(19) United States
(12) Patent Application Publication
(10) Pub. No.: US 2024/0411894 A1
(43) Pub. Date: Dec. 12, 2024

(54) SYSTEMS AND METHODS FOR VULNERABILITY REMEDIATION BASED ON AGGREGATE RISK AND SHARED CHARACTERISTICS

(71) Applicant: Orca Security Ltd., Tel Aviv-Yafo (IL)

(72) Inventor: Avi SHUA, Tel Aviv-Yafo (IL)

(73) Assignee: Orca Security Ltd., Tel Aviv-Yafo (IL)

(21) Appl. No.: 18/732,756

(22) Filed: Jun. 4, 2024

Related U.S. Application Data
(60) Provisional application No. 63/506,535, filed on Jun. 6, 2023.

(51) Int. Cl. G06F 21/57

(52) U.S. Cl. CPC G06F 21/577; G06F 2221/034

(57) ABSTRACT

Disclosed herein are methods, systems, and computer-readable media for vulnerability management. In an embodiment, a method may include a step of identifying a series of vulnerabilities. In some embodiments, the method may further include determining a risk associated with each vulnerability. In some embodiments, the method may include determining one or more characteristics related to a manner of repairing each vulnerability. In some embodiments, the method may further include identifying, based on at least one commonality between the one or more characteristics, one or more subsets of vulnerabilities. In some embodiments, the method may further include displaying the one or more subsets of vulnerabilities in an order, the order being based on the at least one commonality and the determined risk, wherein each subset is enabled to be addressed as a group.

### PRIORITY CLAIM

This application claims priority to U.S. Provisional Application No. 63/506,535, filed on Jun. 6, 2023, the contents of which are hereby incorporated by reference.

### FIELD OF DISCLOSURE

The disclosed embodiments generally relate to systems, devices, methods, and computer readable media for managing or remediating vulnerabilities and other cybersecurity risks in a particular order.

### BACKGROUND

Organizations today face high burdens in making the best use of security tools which detect vulnerabilities and issue alerts based on such detection. In many cases, the number of detected vulnerabilities and issued alerts is high and prioritizing each vulnerability to create an order of vulnerabilities to address becomes more difficult, especially as the number of potential vulnerabilities continues to increase. Even if such security tools provide an ordered list of vulnerabilities to address, organizations may need to perform additional evaluation and analysis to determine if any changes to an automated list should be made, e.g., based on organizational needs, exposure of the vulnerability, or other details specific to the company. In addition, security practitioners do not perform the repairing of a vulnerability themselves and instead typically collaborate with various teams within the organization (e.g., developers, operators, information technology, or administrators) in order to fix an issue based on a particular vulnerability. Existing approaches to managing vulnerabilities fail to take into account at least these considerations and, as a result, do not provide sufficient efficiency, effectiveness, or cost optimization when implementing processes for remediating vulnerabilities.

### SUMMARY

Embodiments of the present disclosure present technological improvements as solutions to one or more of the above-mentioned technical problems recognized by the inventors in conventional systems. For example, some disclosed embodiments may involve identifying a series of vulnerabilities. Some disclosed embodiments may further involve determining a risk associated with each vulnerability of the series of vulnerabilities. Some disclosed embodiments may further involve determining one or more characteristics related to a manner of repairing each vulnerability of the series of vulnerabilities. Some disclosed embodiments may involve identifying, based on at least one commonality between the one or more characteristics, one or more subsets of vulnerabilities from the series of vulnerabilities. Further, some disclosed embodiments may involve displaying the one or more subsets of vulnerabilities in an order, the order being based on the at least one commonality and the determined risk, wherein each subset is enabled to be addressed as a group.

Consistent with some disclosed embodiments, determining the risk may include at least one of identifying a predefined static value or calculating a dynamic value associated with each vulnerability.

Consistent with some disclosed embodiments, the one or more characteristics may include at least one of a cost to repair a particular vulnerability, a source of the particular vulnerability, a potential side effect associated with repairing the particular vulnerability, or a risk reduction value associated with repairing the particular vulnerability. In some disclosed embodiments, the source of the particular vulnerability may include at least one of a source code, a hardware location, an alert location, a location of a change required for remediation, an image (e.g., a virtual disk or container) containing the vulnerability, or an owner (e.g., an individual or entity having ownership of making a change). In some disclosed embodiments, a potential side effect may be determined based on at least one of predefined data or one or more queries.

Some disclosed embodiments may further involve determining an aggregate risk reduction value associated with each subset of vulnerabilities and/or determining an aggregate cost to repair associated with each subset of vulnerabilities. In some disclosed embodiments, the order of repair may further be based on a ratio of the aggregate risk to the aggregate cost of repair.

Some disclosed embodiments may further involve repairing the one or more subsets of vulnerabilities. Consistent with some disclosed embodiments, repairing (e.g., addressing) one or more subsets may include making at least one change to repair at least one vulnerability of the one or more subsets. In some disclosed embodiments, a method may further comprise a step of verifying at least one change or validating one or more side effects associated with the at least one change. Validating may refer to assessing, justifying, affirming, approving, or confirming.

Some disclosed embodiments may involve a system comprising at least one memory storing instructions and/or at least one processor configured to execute instructions to perform operations for vulnerability management. In some disclosed embodiments, the operations may comprise identifying a series of vulnerabilities, determining a risk associated with each vulnerability of the series of vulnerabilities, determining one or more characteristics related to a manner of repairing each vulnerability of the series of vulnerabilities, identifying, based on at least one commonality between the one or more characteristics, one or more subsets of vulnerabilities from the series of vulnerabilities, and/or displaying the one or more subsets of vulnerabilities in an order, the order being based on the at least one commonality and the determined risk, wherein each subset is enabled to be addressed as a group.

Some disclosed embodiments may involve a non-transitory computer-readable medium including instructions that are executable by one or more processors to perform operations. In some embodiments, the operations may comprise identifying a series of vulnerabilities, determining a risk associated with each vulnerability of the series of vulnerabilities, determining one or more characteristics related to a manner of repairing each vulnerability of the series of vulnerabilities, identifying, based on at least one commonality between the one or more characteristics, one or more subsets of vulnerabilities from the series of vulnerabilities, and/or displaying the one or more subsets of vulnerabilities in an order, the order being based on the at least one commonality and the determined risk, wherein each subset is enabled to be addressed as a group.

Other systems, methods, and computer-readable media are also discussed within.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 illustrates an exemplary method for vulnerability or cybersecurity risk management according to some embodiments of the present disclosure.

FIG. 2 illustrates another exemplary method for vulnerability or cybersecurity risk management according to some embodiments of the present disclosure.

FIG. 3 is a block diagram illustrating an exemplary operating environment for implementing various aspects of this disclosure, according to some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are neither constrained to a particular order or sequence nor constrained to a particular system configuration. Additionally, some of the described embodiments or elements thereof can occur or be performed (e.g., executed) simultaneously, at the same point in time, or concurrently. Reference will now be made in detail to the disclosed embodiments, examples of which are illustrated in the accompanying drawings.

It is to be understood that both the foregoing general description and the following detailed description are exemplary and explanatory only and are not restrictive of this disclosure. The accompanying drawings, which are incorporated in and constitute a part of this specification, illustrate several exemplary embodiments and together with the description, serve to outline principles of the exemplary embodiments.

This disclosure may be described in the general context of customized hardware capable of executing customized preloaded instructions such as, e.g., computer-executable instructions for performing program modules. Program modules may include one or more of routines, programs, objects, variables, commands, scripts, functions, applications, components, data structures, and so forth, which may perform particular tasks or implement particular abstract data types. The disclosed embodiments may also be practiced in distributed computing environments where tasks are performed by remote processing devices that are linked through a communications network. In a distributed computing environment, program modules may be located in local and/or remote computer storage media including memory storage devices.

In exemplary embodiments, systems and methods are disclosed for providing vulnerability or cybersecurity risk management solutions which include determining a particular order of displaying, addressing, and/or repairing identified vulnerabilities and/or cybersecurity risk. Technical advantages resulting from disclosed embodiments include improved risk reduction (e.g., identifying and addressing vulnerabilities in groups and based on a combination of parameters to more efficiently reduce overall risk exposure, implement appropriate security controls and countermeasures, and minimize the likelihood of successful attacks), improved patching (e.g., applying security patches and updates at once to linked vulnerabilities or cybersecurity risks thereby improving timeliness and efficiency), enhanced security posture (e.g., making better informed decisions regarding security investments, remediation efforts, and resource allocation, based on common characteristics shared among vulnerabilities or cybersecurity risks), proactive threat prevention (e.g., addressing vulnerabilities and/or cybersecurity risks in groups to remediate all related vulnerabilities at once, thereby reducing the likelihood of exploitation of several vulnerabilities and/or risks in fewer steps), and improved asset management (e.g., including the determined common characteristics between particular vulnerabilities and/or cybersecurity risks in an updated inventory of systems and assets, thereby enhancing the visibility and organization of all hardware, software, and network components).

Using the techniques described herein, the disclosure may further help minimize overall organizational burden in remediating vulnerabilities and cybersecurity risks. By identifying subsets of vulnerabilities and/or cybersecurity risks that may be addressed in groups, the systems and methods described herein enable more efficient remediation as well as lower costs. Exemplary embodiments may include determining the subsets, as well as an order thereof, based on, e.g., risk associated with vulnerabilities and/or cybersecurity risks, risk reduction associated with remediation, common characteristics amongst vulnerabilities or other cybersecurity risks, side effects of remediation, and/or costs of remediation. As a result, users may reduce the organizational burdens associated with remediating vulnerabilities and cybersecurity risks, e.g., by increasing efficiency and effectiveness and/or by lowing associated costs.

Illustrative embodiments of the present disclosure are described below. In exemplary embodiments, the management processes may comprise the following phases. In some embodiments, the steps in the methods described herein may be duplicated, omitted, executed in any order, or modified to use in various situations.

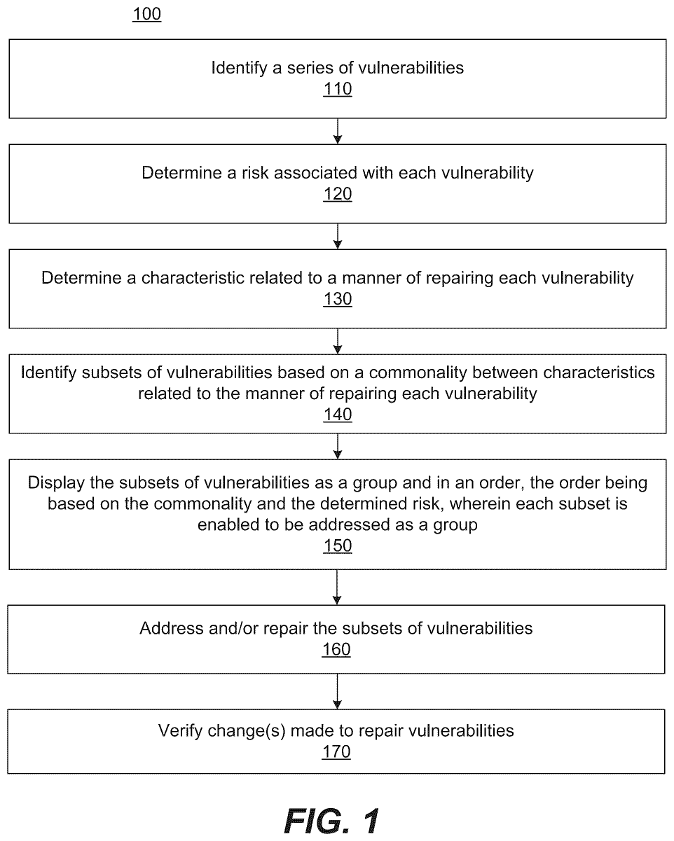

In one embodiment, and with reference to FIG. 1, a computer-implemented method 100 for vulnerability and cybersecurity risk management in containerized environments (or other environments) may comprise a step 110 of identifying a series of vulnerabilities. A series of vulnerabilities may refer to one or more sets comprising any number of vulnerabilities. A vulnerability may include any weakness, flaw, or error existing within a secured system or network that has the potential to be leveraged, or that which is actively or currently being leveraged, by a threat agent in order to compromise one or more computer environments. For example, vulnerabilities may include software vulnerabilities, network vulnerabilities, web application vulnerabilities, hardware vulnerabilities, social engineering vulnerabilities, configuration vulnerabilities, physical vulnerabilities, denial-of-service vulnerabilities, cryptographic vulnerabilities, mobile application vulnerabilities, and other exploitable or exploited weaknesses.

In addition, vulnerabilities may include other cybersecurity risks, such as, e.g., zero-day and/or future vulnerabilities (e.g., security flaws in software or hardware which are unknown to a vendor or developer, or vulnerabilities which have no current remediation or defenses available to prevent exploitation), advanced persistent threats (e.g., sophisticated, multi-stage, and/or prolonged cyber attacks, potentially being carried out by well-funded or skilled adversaries, such as, e.g., nation-states, organized crime groups, or hacking organizations), data privacy risks (e.g., threats to the confidentiality, integrity, or availability of personal or sensitive information, potentially including unauthorized access, data breaches, data theft, data misuse, lack of data minimization, insufficient data anonymization, third-party risks, weak encryption or security controls, or compliance violations, and potentially resulting in financial loss, reputation damage, legal or regulatory penalties, identity theft, identity fraud, operational disruption, or loss of competitive advantage), regulatory compliance risks (e.g., lack of adherence to laws, regulations, guidelines, or specifications relevant to business operations, as set by government bodies, industry standards, or internal policies), security misconfigurations (e.g., default settings, unnecessary settings, insecure configuration of security tools, lack of updates, improper access controls, inadequate encryption, improper error handling, misconfigured cloud services, and other errors or oversights in the configuration of security settings within software, hardware, or network devices, occurring at various potential levels, such as, e.g., application, server, network, or cloud environments), known and/or unknown malware (e.g., software designed to harm, exploit, or otherwise compromise the functionality, integrity, or data of a computer system, network, or device), exposure risks (e.g., potential threats that may lead to unauthorized access, disclosure, alteration, or destruction of sensitive information or systems), identity or privilege issues (challenges related to the management of user identities and their access rights within an organization's IT environment, such as, e.g., weak authentication or credentials, insufficient verification, excessive privileges, lack of privilege managements, shared accounts, or orphaned accounts), lateral movement risks (e.g., deviations from best practices, and suspicious and/or malicious activity (e.g., threats associated with an attacker moving laterally within a compromised network, such as, e.g., stolen credentials, exploited trust relationships, misconfigured security controls, lack of network segmentation or multi-factor authorization, weak access controls, lack of regular patch management, lack of endpoint detection and response, lack of behavioral monitoring, lack of regular security auditing, lack of incident response plans, or poor user education or awareness), deviations from best practices (e.g., failures to follow established guidelines, standards, or recommended procedures for securing their systems and data, such as, e.g., weak password policies, lack of regular updates or data backups, insufficient access controls, lack of security monitoring, lack of security training, or lack of encryption), and suspicious activity (e.g., actions or behaviors that are abnormal or unusual, including, e.g., unusual or abnormal access patterns, file access, network traffic, access attempts, changes, processes, applications, or other behavioral anomalies), or malicious activity (e.g., actions or behaviors intended to cause harm, compromise security, or gain unauthorized access to systems or data, including, e.g., data exfiltration, ransomware, automated activity, command and control communication, or social engineering attempts).

Identifying, as used herein, may refer to recognizing, spotting, determining, pinpointing, detecting, characterizing, labelling, diagnosing, verifying, confirming, ascertaining, finding, naming, qualifying, accessing, receiving (e.g., from an external source), selecting, or describing. For example, various deployed systems of a particular organizational network may be mapped and analyzed using provider application programming interfaces (APIs), specialized sensors or vulnerability scanning tools, and/or side scanning techniques utilizing agentless scanning tools. With regard to side scanning techniques, the disclosure of U.S. Pat. No. 11,489,863, filed on Apr. 8, 2022, titled FOUNDATION OF SIDESCANNING, is hereby incorporated by reference in its entirety. As a result of the identifying, a series of vulnerabilities may be determined with relation to the organizational computing environment.

In some embodiments, method 100 may further include a step 120 of determining a risk associated with each vulnerability of the series of vulnerabilities. A risk, as used herein, may refer to a possibility, chance, or likelihood of severity, danger, harm, loss, or other negative result, impact, or event associated with the exploitation of a vulnerability. Determining a risk may include identifying a score, rating, percentage, category, or other value that is indicative of the amount of risk. In some embodiments, determining a risk may include at least one of identifying a predefined static value or calculating a dynamic value associated with a detected vulnerability. As such, determining a risk associated with a detected vulnerability may be performed statically, dynamically, or via a combination of static and dynamic methods. Static methods may include, e.g., determining a value indicating an amount of risk based on a predefined severity (or other value) associated with the vulnerability or a type of alert associated with the vulnerability. For example, a type of vulnerability or a type of alert may be categorized as low risk, medium risk, or high risk based on predefined values which are associated with various types of vulnerabilities or alerts. Dynamic methods may include, e.g., determining a value indicating an amount of risk based on a present or current environment and/or an amount of exposure associated with the vulnerability. For example, a vulnerability that may be exploitable from the internet may have an associated risk higher than an associated risk of a vulnerability that is exploitable only from an internal network (e.g., an intranet). Other dynamic methods may include, e.g., determining risk based on opportunity costs, communication costs, potential reputational cost, potential legal repercussions, ongoing maintenance costs, or a combination thereof.

In some embodiments, method 100 may further include a step 130 of determining one or more characteristics related to a manner of repairing each vulnerability of the series of vulnerabilities. Characteristics, as used herein, may include any feature or quality belonging to or associated with the vulnerability itself or with a manner of repairing the vulnerability. For example, characteristics may include a cost to repair a particular vulnerability, a source of a particular vulnerability, an image (e.g., a virtual disk or container) which is the source of the vulnerability, a group or individual likely responsible for fixing the vulnerability, a potential side effect associated with repairing the particular vulnerability, or a risk reduction value associated with repairing a particular vulnerability.

A cost to repair may be determined using static methods, dynamic methods, or a combination thereof (as previously described and exemplified). A cost to repair a particular vulnerability may refer to, e.g., an equipment cost (e.g., a monetary value associated with technically repairing a particular vulnerability, which may be related to changes in hardware or software, or newly required equipment or licenses), a labor cost (e.g., a monetary value associated with human or computer-implemented resources required in repairing a particular vulnerability, an amount of time required for repairing a particular vulnerability, or an amount of effort required for repairing a particular vulnerability), a downtime cost (e.g., losses in productivity and/or revenue from taking a system offline temporarily in order to repair a particular vulnerability), a testing cost (e.g., costs related to verifying the vulnerability has been repaired and that new issues have not been introduced by the repair, or costs for testing equipment or personnel), a compliance cost (e.g., costs related to auditing or reporting based on industry or government regulations), a processing cost (e.g., expenses, burdens, or time associated with labor cost, equipment cost, material cost, computational cost, or overhead/indirect costs), or a combination thereof.

A source of a particular vulnerability may refer to an identifier indicating where repair or remediation should occur. In some embodiments, a source of a particular vulnerability may include a source code (e.g., a software or project location, a file or folder location, and/or a module), a hardware location (e.g., a particular server, storage medium, switch, port, and/or other network device or component), an alert location (e.g., a location where an alert originated or where an alert was triggered), or an owner (e.g., an entity or account responsible for the source code or hardware that is causing the vulnerability). Identifying a source may include methods as described and exemplified in the disclosures of U.S. Provisional Patent Application No. 63/493,227, filed on Mar. 30, 2023, titled SYSTEMS AND METHODS FOR VULNERABILITY REMEDIATION BASED ON CORRELATION OF CONTAINERS WITH SOURCE CODE, and U.S. Provisional Patent Application No. 63/490,585, filed on Mar. 16, 2023, titled SYSTEMS AND METHODS OF GENERATING AUTOMATIC SUGGESTIONS TO CHANGE INFRASTRUCTURE AS CODE TO REMEDIATE CLOUD SECURITY ISSUES, both of which are hereby incorporated by reference in their entireties. As further non-limiting examples, a source of a particular vulnerability may refer to a category or type of vulnerability, such as a software bug (e.g., coding errors, design flaws, or other unintended defects in software), misconfiguration, result of social engineering, result of malware, result of breaches in physical security (e.g., from theft or unauthorized access), exploitation of integrated third-party components, weak password or otherwise flawed authentication mechanism, legacy system (e.g., a system lacking security updates), Internet of Things (IoT) device, cryptographic weakness, hardware vulnerability, or insider threat.

A potential side effect associated with repairing a particular vulnerability may refer to a possible secondary (e.g., downstream) and/or undesirable (e.g., adverse) impact of a change made to repair a vulnerability. In some embodiments, a potential side effect may be determined based on at least one of predefined data or one or more queries. Using predefined data to determine a potential side effect may refer to static methods (as previously described and exemplified). For example, a known side effect of revising source code may be that one or more configurations are adjusted and that verification that the revised source code does not introduce new undesired effects may be required. Based on such predefined data, a potential side effect of revising any source code may include an increase in the cost to repair associated with a vulnerability, which may also be taken into consideration when determining an order of addressing particular vulnerabilities or subsets thereof. Using one or more queries to determine a potential side effect may also refer to dynamic methods (as previously described and exemplified). As a further example of a dynamic method, based on a detected vulnerability of a user accessing a network with administrative privileges, wherein repairing the vulnerability includes reducing the user's permissions, a potential side effect associated with repairing the vulnerability may be that the user will be prohibited from accessing a part of the network that requires the administrative privileges. In such a case, performing a query for the operations performed by that user may verify whether that user actually requires such administrative privileges or permissions. If the query result indicates that the user requires such administrative permissions for operations performed by that user, a potential side effect of reducing the user's permissions may be indicated because that user will no longer have the same access after repair. However, if the query result indicates that the user does not perform operations which require administrative permissions, no such potential side effect may be indicated.

A risk reduction value associated with repairing a particular vulnerability may refer to a value which indicates an amount of risk that may be removed by repairing a particular vulnerability. For example, a risk reduction value may correspond to a determined risk associated with a vulnerability or to a determined risk associated with an exploitation of a computing system component or asset that is linked to a vulnerability (e.g., based on shared access or pathways). In some embodiments, a risk reduction value may be the same as (or the negative value of) a determined risk (or value thereof) associated with a vulnerability. A determined risk (or value thereof) may include or be based on a risk associated with a vulnerability (e.g., the ease with which the vulnerability may be exploited), an exposure associated with the vulnerability (e.g., the amount of access associated with the vulnerability), and/or the potential impact of the vulnerability (e.g., the results of a breach via the vulnerability). In some embodiments, the determination of a risk reduction value (or a determined risk) may be performed based on one or more calculations (e.g., the combination of values associated with the risk, the exposure, and/or the potential impact). In other embodiments, the determination of a risk reduction value may be performed based on data in a shared lookup table.

In some embodiments, method 100 may also include a step 140 of identifying, based on at least one commonality between the one or more characteristics, one or more subsets of vulnerabilities from the series of vulnerabilities. A commonality, as used herein, may refer to a shared feature or attribute between characteristics. For example, a commonality may include a shared cost to repair particular vulnerabilities, a shared source of particular vulnerabilities, a shared potential side effect associated with repairing particular vulnerabilities, a shared risk reduction value associated with repairing particular vulnerabilities, or a combination thereof. A subset of vulnerabilities, as used herein, may refer to a group comprising at least one vulnerability from an identified series of vulnerabilities.

In some embodiments, method 100 may further include a step 150 of displaying (e.g., to one or more users) the one or more subsets of vulnerabilities in an order, the order being based on the at least one commonality and the determined risk, wherein each subset of vulnerabilities may be enabled to be addressed and/or repaired as a group before a next subset of vulnerabilities is addressed and repaired, also as a group. For example, a first subset of vulnerabilities may be associated with a high risk and a high cost of repair, and a second subset of vulnerabilities may be associated with a high risk, albeit lower than the risk associated with the first subset, and a low cost of repair. While conventional systems will display and prioritize the first subset over the second subset based solely on the amount of associated risk, a method according to some disclosed embodiments may take into account the amount of associated risk, the cost of repair, and the cost effectiveness of each subset of vulnerabilities as a whole. As a result, the second subset may be displayed to be prioritized for repair over the first subset due to the lower cost of repair and given the small discrepancy between associated risks. Under conventional methods, remediation of the second subset of vulnerabilities may be unreasonably delayed due to the high cost of repair associated with the first subset, allowing for an unnecessarily longer period of time during which exploitation of the vulnerability may occur. Under the present disclosure, the second subset of vulnerabilities would be displayed to be prioritized and remediated more quickly than the first subset of vulnerabilities due to the lower cost of repair, after which the first subset of vulnerabilities may be addressed.

As another example, a detected series of vulnerabilities may initially be displayed to be prioritized for repair based on a determined risk associated with each vulnerability within the series. Under conventional systems, each of these vulnerabilities will be addressed in the order of prioritization, which may increase organizational burden due to a lack of additional considerations. Under the present disclosure, however, a second factor (e.g., a source of each vulnerability) may be considered in order to identify subsets of vulnerabilities having a common source. Based on the additional consideration of a common source, subsets of vulnerabilities having a common source, and regardless of any order based on associated risk alone, may be identified such that each subset may be addressed (e.g., remediated or repaired) as a group. By addressing each subset as a group, a source of the vulnerabilities (as well as individuals associated with the source) may be accessed and utilized during a single period of time such that all vulnerabilities stemming from that source may be repaired as a group. This approach saves both time and resources required to repair the vulnerabilities and thereby reduces the organizational burden associated with repairing the subset of vulnerabilities. This approach also allows for a single round of testing the changes made and a single round of deploying the verified changes while remediating groups of vulnerabilities sharing a common characteristic.

According to some disclosed embodiments, method 100 may further include a step 160 of addressing or repairing the one or more subsets of vulnerabilities. In some embodiments, addressing or repairing the one or more subsets of vulnerabilities may include making at least one change to remediate at least one vulnerability of the one or more subsets of vulnerabilities, and method 100 may include a step 170 of verifying the at least one change made to repair the at least one vulnerability, and/or validating a side effect or risk associated with the at least one change, prior to deploying the change.

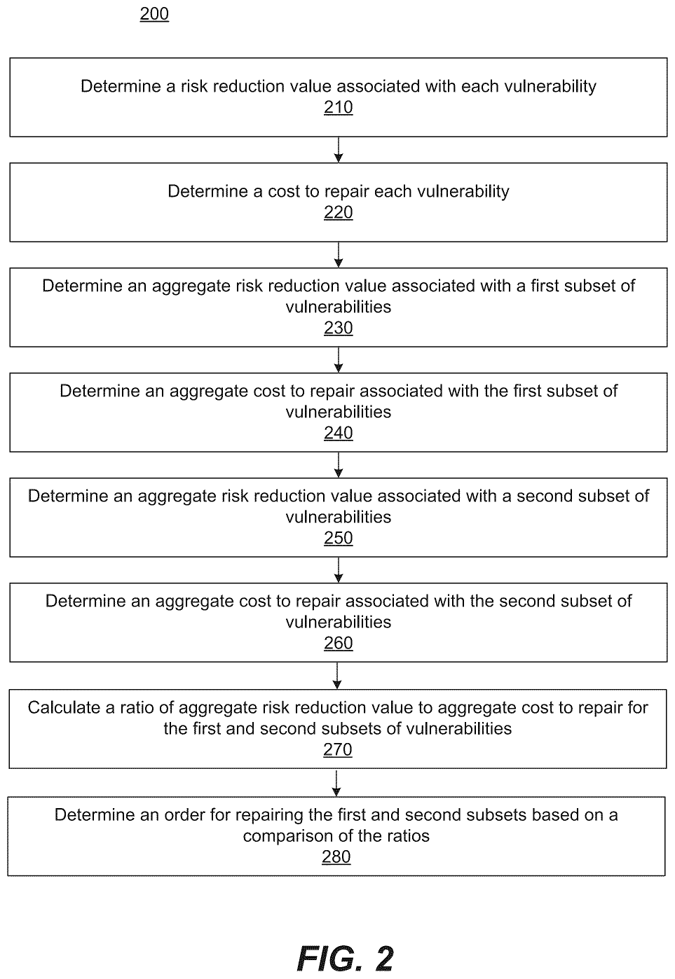

FIG. 2 illustrates an exemplary method 200, consistent with disclosed embodiments, for determining aggregate values associated with particular subsets of vulnerabilities, and based on the aggregate values, determining an order in which to address or repair the subsets of vulnerabilities. In exemplary embodiments, such processes may comprise the following phases. In some embodiments, the steps in method 200 may be duplicated, omitted, executed in any order, or modified to use in various situations.

In some embodiments, method 200 may include a step 210 of determining a risk reduction value associated with each vulnerability within a series of vulnerabilities. A risk reduction value associated with repairing each vulnerability may refer to a value which indicates an amount of risk that may be removed by repairing a particular vulnerability. For example, a risk reduction value may correspond to a determined risk associated with a vulnerability. In some embodiments, a risk reduction value may be the same as a determined risk associated with a vulnerability (e.g., if a determined risk associated with a vulnerability is high, a risk reduction value associated with that vulnerability may also be high).

In some embodiments, method 200 may include a step 220 of determining a cost to repair each vulnerability. A cost to repair each vulnerability (as previously described and exemplified) may be determined using static methods, dynamic methods, or a combination thereof (as previously described and exemplified).

In some embodiments, given the determined risk reduction values associated with each vulnerability, method 200 may include a step 230 of determining an aggregate risk reduction value associated with a first subset of vulnerabilities. An aggregate risk reduction value, as used herein, may refer to a combined risk reduction value associated with a subset of vulnerabilities which are grouped based on an identifier (e.g., a commonality between one or more characteristics) (as previously described and exemplified). Determining an aggregate risk reduction value associated with a first subset of vulnerabilities may include, e.g., adding together or averaging individual risk reduction values associated with each vulnerability within the first subset, or otherwise calculating a total risk reduction value based on a total number of vulnerabilities, the individual risk reduction values associated with each vulnerability within the first subset, and the potential for overlapping risk reduction values associated with vulnerabilities which may be repaired as a group via a common change.

In some embodiments, given the determined costs to repair each vulnerability, method 200 may include a step 240 of determining an aggregate cost to repair associated with the first subset of vulnerabilities. An aggregate cost to repair, as used herein, may refer to an incremental cost associated with repairing a subset of vulnerabilities which are grouped based on an identifier (e.g., a commonality between one or more characteristics) (as previously described and exemplified). It will be understood that an incremental cost may be significantly less than a combination of individual costs to sequentially repair each vulnerability within a subset. Determining an aggregate cost to repair associated with a first subset of vulnerabilities may include, e.g., accounting for the fact that repairing multiple vulnerabilities sharing a common characteristic (e.g., a common source, location, owner, or other characteristic) as a group may significantly decrease the overall cost of repair associated with a combination of vulnerabilities, particularly as compared to an overall cost of repair if the same combination of vulnerabilities were to be addressed in a sequence based on an associated risk alone. Such decreases in overall cost to repair may be the result of, e.g., reduction of at least one of organizational friction, communication requirements, testing and verification requirements, or deployment requirements. Determining an aggregate cost to repair associated with a first subset of vulnerabilities may also include, e.g., accounting for downstream impacts (e.g., potential side effects) associated with repairing the first subset prior to repairing a different subset of vulnerabilities. It will be understood that an aggregate cost to repair associated with a particular subset of vulnerabilities may be less than the sum of individual costs to repair each separate vulnerability within that subset.

In some embodiments, after determining an aggregate risk reduction value and an aggregate cost to repair associated with the first subset of vulnerabilities, method 200 may include a step 250 of determining an aggregate risk reduction value (as previously described and exemplified) associated with a second subset of vulnerabilities.

In some embodiments, method 200 may include a step 260 of determining an aggregate cost to repair (as previously described and exemplified) associated with the second subset of vulnerabilities.

In some embodiments, after aggregate risk reduction values and aggregate costs to repair are determined for the first and second subsets of vulnerabilities, method 200 may include a step 270 of calculating a ratio of aggregate risk reduction value to aggregate cost to repair for the first and second subsets of vulnerabilities (e.g., a first ratio and a second ratio). A ratio, as used herein, may refer to a quantitative relation between two values, or a comparison in terms of a quotient of two values (e.g., wherein the first value is an aggregate risk reduction value and the second value is an aggregate cost to repair, relative to the same subset of vulnerabilities). The ratio may therefore provide a value indicative of an amount of total return on investment (ROI) related to remediation of a given subset of vulnerabilities. Further, based on the determined ratio, an ROI level may be determined (e.g., on a scale of 1 to 5, with a value of 5 indicating the highest ROI, and with a value of 1 indicating the lowest ROI).

In some embodiments, method 200 may further include a step 280 of determining an order for repairing at least the first and second subsets based on a comparison of at least the first and second ratios. Determining an order may include identifying a higher ratio (e.g., a higher ROI) and a lower ratio (e.g., a lower ROI) and prioritizing the subset having the higher ratio of aggregate values over the subset having the lower ratio of aggregate values.

According to other embodiments of the present disclosure, a system for managing vulnerabilities may be provided. In some embodiments, a system may include at least one memory storing instructions and at least one processor configured to execute the instructions to perform a set of operations for vulnerability management. The set of operations may mirror the steps of the method 100 described herein. As such, the system may be configured for identifying a series of vulnerabilities. The system may also be configured for determining a risk associated with each vulnerability of the series of vulnerabilities. The system may further be configured for determining one or more characteristics related to a manner of repairing each vulnerability of the series of vulnerabilities. Further, the system may be configured for identifying, based on at least one commonality between the one or more characteristics, one or more subsets of vulnerabilities from the series of vulnerabilities. The system may be configured for displaying the one or more subsets of vulnerabilities in an order, the order being based on the at least one commonality and the determined risk, wherein each subset is enabled to be addressed as a group.

According to another embodiment of the present disclosure, a non-transitory computer readable medium comprising instructions to perform steps for managing vulnerabilities in containerized environments may be provided. The steps embodied in the instructions of the non-transitory computer readable medium may mirror the steps of the method 100 described herein. As such, the steps may be configured for identifying a series of vulnerabilities. The steps may also be configured for determining a risk associated with each vulnerability of the series of vulnerabilities. The steps may further be configured for determining one or more characteristics related to a manner of repairing each vulnerability of the series of vulnerabilities. Further, the steps may be configured for identifying, based on at least one commonality between the one or more characteristics, one or more subsets of vulnerabilities from the series of vulnerabilities. The steps may also be configured for displaying the one or more subsets of vulnerabilities in an order, the order being based on the at least one commonality and the determined risk, wherein each subset is enabled to be addressed as a group.

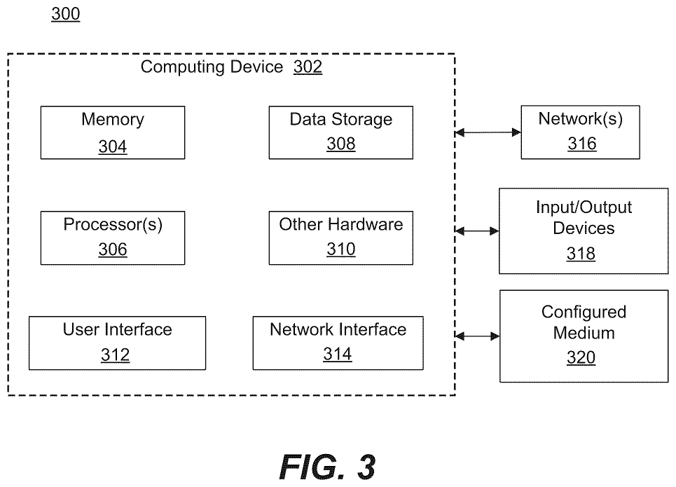

An exemplary operating environment for implementing various aspects of this disclosure is illustrated in FIG. 3. As illustrated in FIG. 3, an exemplary operating environment 300 may include a computing device 302 (e.g., a general-purpose computing device) in the form of a computer. In some embodiments, computing device 302 may be associated with a user. Components of the computing device 302 may include, but are not limited to, various hardware components, such as one or more processors 306, data storage 308, a system memory 304, other hardware 310, and a system bus (not shown) that couples (e.g., communicably couples, physically couples, and/or electrically couples) various system components such that the components may transmit data to and receive data from one another. The system bus may be any of several types of bus structures including a memory bus or memory controller, a peripheral bus, an address bus, a data bus, a control bus, and a local bus using any of a variety of bus architectures. By way of example, and not limitation, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

With further reference to FIG. 3, an operating environment 300 for an exemplary embodiment includes at least one computing device 302. The computing device 302 may be a uniprocessor or multiprocessor computing device. An operating environment 300 may include one or more computing devices (e.g., multiple computing devices 302) in a given computer system, which may be clustered, part of a local area network (LAN), part of a wide area network (WAN), part of a metropolitan area network (MAN), part of a wireless network, client-server networked, peer-to-peer networked within a cloud, or otherwise communicably linked. A network may include a vertical network, a chain network, a circuit network, a wheel or spoke network, a star network, or another type of network. A computer system may include an individual machine or a group of cooperating machines. A given computing device 302 may be configured for end-users, e.g., with applications, for administrators, as a server, as a distributed processing node, as a special-purpose processing device, or otherwise configured. In some embodiments, multiple computing devices 302 (e.g., a network of GPUs) may be configured together.

One or more users may interact with the computer system comprising one or more computing devices 302 by using a display, keyboard, mouse, microphone, touchpad, camera, sensor (e.g., touch sensor) and other input/output devices 318, via typed text, touch, voice, movement, computer vision, gestures, and/or other forms of input/output. An input/output device 318 may be removable (e.g., a connectable mouse or keyboard) or may be an integral part of the computing device 302 (e.g., a touchscreen, a built-in microphone). A user interface 312 may support interaction between an embodiment and one or more users. A user interface 312 may include one or more of a command line interface (CLI), graphical user interface (GUI), menu-driven user interface, voice user interface, touch user interface, form-based user interface, natural language user interface, and/or other user interface (UI) presentations, which may be presented as distinct options or may be integrated. A user may enter commands and information through a user interface or other input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs using hands or fingers, or other natural user input may also be used with the appropriate input devices, such as a microphone, camera, tablet, touch pad, glove, or other sensor. These and other input devices are often connected to the processing units through a user input interface that is coupled to the system bus, but may be connected by other interface and bus structures, such as a parallel port, a game port, or a universal serial bus (USB). A monitor or other type of display device may also be connected to the system bus via an interface, such as a video interface. The monitor may also be integrated with a touch-screen panel or the like. Note that the monitor and/or touch screen panel can be physically coupled to a housing in which the computing device is incorporated, such as in a tablet-type personal computer. In addition, computers such as the computing device may also include other peripheral output devices such as speakers, headphones, monitors, projectors, readers, or a printer, which may be connected through an output peripheral interface or the like.

One or more application programming interface (API) calls may be made between input/output devices 318 and computing device 302, based on input received at user interface 312 and/or from network(s) 316. As used throughout, “based on” may refer to being established or founded upon a use of, changed by, influenced by, caused by, dependent upon, or otherwise derived from. In some embodiments, an API call may be configured for a particular API, and may be interpreted and/or translated to an API call configured for a different API. As used herein, an API may refer to a defined (e.g., according to an API specification) interface or connection between computers or between computer programs. An API specification may refer to a broad and language-agnostic description of how an API functions, data types supported by the API, the fundamental design philosophy of the API, and how the API links with other APIs.

Various types of users may interact with computing device 302 via one or more API calls and/or via a direct input via input/output devices 318. System administrators, network administrators, software developers, engineers, and end-users may each be a particular type of user. Automated agents, scripts, playback software, and the like, acting on behalf of one or more people, may also constitute a type of user. Storage devices and/or networking devices may be considered peripheral equipment in some embodiments and part of a system comprising one or more computing devices 302 in other embodiments, depending on their detachability from the processor(s) 306. Other computerized devices and/or systems not shown in FIG. 3 may interact in technological ways with computing device 302 or with another system using one or more connections to a network 316 via a network interface 314, which may include network interface equipment, such as a physical network interface controller (NIC) or a virtual network interface (VIF).

Computing device 302 includes at least one logical processor 306. The at least one logical processor 306 may include circuitry and transistors configured to execute instructions from memory (e.g., memory 304). For example, the processor(s) 306 may include one or more central processing units (CPUs), control units (CUs), arithmetic logic units (ALUs), registers, clocks, Floating Point Units (FPUs), and/or Graphics Processing Units (GPUs). The computing device 302, like other suitable devices, may also include one or more computer-readable storage media, which may include, but are not limited to, memory 304 and data storage 308. Computer-readable storage media may refer to any medium capable of storing data in a format that is easily processed by a digital computer or easily readable by a mechanical device. In some embodiments, memory 304 and data storage 308 may be part of a single memory component. The one or more computer-readable storage media may be of different physical types. The media may be volatile memory, non-volatile memory, fixed in place media, removable media, magnetic media, optical media, solid-state media, and/or of other types of physical durable storage media (as opposed to merely a propagated signal). In particular, a configured medium 320 such as a portable (i.e., external) hard drive, compact disc (CD), Digital Versatile Disc (DVD), memory stick, mobile device, tablet device, USB device, or other removable non-volatile memory medium may become functionally a technological part of the computer system when inserted or otherwise installed with respect to one or more computing devices 302, making its content accessible for interaction with and use by processor(s) 306. The removable configured medium 320 is an example of a computer-readable storage medium. Some other examples of computer-readable storage media include built-in random access memory (RAM), read-only memory (ROM), hard disks, and other memory storage devices which are not readily removable by users (e.g., memory 304).

The configured medium 320 may be configured with instructions (e.g., binary instructions) that are executable by a processor 306; “executable” is used in a broad sense herein to include machine code, interpretable code, bytecode, compiled code, and/or any other code that is configured to run on a machine, including a physical machine or a virtualized computing instance (e.g., a virtual machine or a container). For example, an executable file may be a computer file that contains an encoded sequence of instructions that a system can execute directly when instructed by a user. The configured medium 320 may also be configured with data which is created by, modified by, referenced by, and/or otherwise used for technical effect by execution of the instructions. The instructions and the data may configure the memory or other storage medium in which they reside; such that when that memory or other computer-readable storage medium is a functional part of a given computing device, the instructions and data may also configure that computing device.

Although an embodiment may be described as being implemented as software instructions executed by one or more processors in a computing device (e.g., general-purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include other hardware logic components 310 such as Programmable Network Devices (e.g., switches, smart network interface cards), Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), Simple Programmable Logic Devices (SPLDs), and similar components. Components of an embodiment may be grouped into interacting functional modules based on their inputs, outputs, and/or their technical effects, for example.

In addition to processor(s) 306, memory 304, data storage 308, and screens/displays, an operating environment 300 may also include other hardware 310, such as batteries, buses, power supplies, wired and wireless network interface cards, additional input devices, additional processing devices, communication devices, persistent storage devices, and motherboards, for instance. The nouns “screen” and “display” are used interchangeably herein. A display may include one or more touch screens, screens responsive to input from a pen or tablet, or screens which operate solely for output. In some embodiment, other input/output devices 318 such as human user input/output devices (screen, keyboard, mouse, tablet, microphone, speaker, motion sensor, etc.) will be present in operable communication with one or more processors 306 and memory 304.

In some embodiments, the operating environment 300 may include multiple computing devices 302 connected by network(s) 316. Networking interface equipment can provide access to network(s) 316, using components (which may be part of a network interface 314) such as a packet-switched network interface card, a wireless transceiver, or a telephone network interface, for example, which may be present in a given computer system. However, an embodiment may also communicate technical data and/or technical instructions through direct memory access, removable non-volatile media, or other information storage-retrieval and/or transmission approaches including but not limited to correspondence files, accounting systems, inventory-control systems, directories, indexing systems, and query systems.

The computing device 302 may operate in a personal environment, a private environment, or a networked or cloud-computing environment using logical connections to one or more remote devices (e.g., using network(s) 316), such as a remote computer (e.g., another computing device 302). The remote computer may include one or more of a personal computer, a server, a router, a network PC, or a mobile device or other common network node, and may include any or all of the elements described above relative to the computer. The logical connections may include one or more LANs, WANs, virtual networks, and/or the Internet.

When used in a networked or cloud-computing environment, computing device 302 may be connected to a public or private network through a network interface controller, a physical network interface, or a network adapter (e.g., a LAN or WAN adapter). A network interface or adapter may refer to a hardware component responsible for connecting a computing device to a computer network. In some embodiments, a modem or other communication connection device may be used for establishing communications over the network. The modem, which may be internal or external, may be connected to the system bus via a network interface or other appropriate mechanism. A wireless networking component such as one comprising an interface and antenna may be coupled through a suitable device such as an access point or peer computer to a network. In a networked environment, program modules depicted relative to the computer, or portions thereof, may be stored in the remote memory storage device. It may be appreciated that the network connections shown are exemplary and other means of establishing a communications link between the computers may be used.

Computing device 302 typically may include any of a variety of computer-readable media. Computer-readable media may be any available media that can be accessed by the computer and includes both volatile and nonvolatile media, and removable and non-removable media, but excludes propagated signals. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, electrically erasable programmable read-only memory (EEPROM), flash memory or other memory technology, CD-ROM, DVD or other optical disk storage, magnetic cassettes, magnetic tape, magnetic disk storage or other magnetic storage devices, or any other medium which can be used to store the desired information (e.g., program modules, data for an artificial intelligence model, and/or an artificial intelligence model itself) and which can be accessed by the computer. Communication media may embody computer-readable instructions, data structures, program modules or other data in a modulated data signal. The term “modulated data signal” means a signal that has one or more of its characteristics set or changed in such a manner as to encode information in the signal. By way of example, and not limitation, communication media includes wired media such as a wired network, direct-wired connection, analog or digital connection, twisted pair connection, coaxial connection, ethernet, or fiber optic connection, and wireless media such as acoustic, radio frequency (RF), infrared, broadcast, cellular, microwave, satellite, and other wireless media. Combinations of the any of the above may also be included within the scope of computer-readable media. Computer-readable media may be embodied as a computer program product, such as software (e.g., including program modules) stored on non-transitory computer-readable storage media.

The data storage 308 or system memory includes computer storage media in the form of volatile and/or nonvolatile memory such as ROM and RAM. ROM may refer to a type of computer storage containing non-volatile, permanent data that, normally, can only be read, not written to or changed. RAM may refer to a form of computer memory that can be read and written to or changed in any order. A basic input/output system (BIOS), containing the basic routines that help to transfer information between elements within computer, such as during start-up, may be stored in ROM. RAM may contain data and/or program modules that are immediately accessible to and/or presently being operated on by processing unit. By way of example, and not limitation, data storage holds an operating system, application programs, and other program modules and program data.

Data storage 308 may also include other removable/non-removable, volatile/nonvolatile computer storage media. By way of example only, data storage may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Forms of data storage may include file storage, block storage, object storage, direct-attached storage, and/or network-based storage.

Exemplary disclosed embodiments include systems, methods, and computer-readable media for managing vulnerabilities in containerized environments. For example, in some embodiments, and as illustrated in FIG. 3, an operating environment 300 may include at least one computing device 302, the at least one computing device 302 including at least one processor 306, at least one memory 304, at least one data storage 308, and/or any other component discussed above with respect to FIG. 3.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Example embodiments are described above with reference to flowchart illustrations or block diagrams of methods, apparatus (systems) and computer program products. It will be understood that each block of the flowchart illustrations or block diagrams, and combinations of blocks in the flowchart illustrations or block diagrams, can be implemented by computer program product or instructions on a computer program product. These computer program instructions may be provided to a processor of a computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer-readable medium that can direct one or more hardware processors of a computer, other programmable data processing apparatus, or other devices to function in a particular manner, such that the instructions stored in the computer-readable medium form an article of manufacture including instructions that implement the function/act specified in the flowchart or block diagram block or blocks.

The computer program instructions may also be loaded onto a computer, other programmable data processing apparatus, or other devices to cause a series of operational steps to be performed (e.g., executed) on the computer, other programmable apparatus or other devices to produce a computer implemented process such that the instructions that execute on the computer or other programmable apparatus provide processes for implementing the functions/acts specified in the flowchart or block diagram block or blocks.

Any combination of one or more computer-readable medium(s) may be utilized. The computer-readable medium may be a non-transitory computer-readable storage medium. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber cable, RF, IR, etc., or any suitable combination of the foregoing.

Computer program code for carrying out operations, for example, embodiments may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

The flowchart and block diagrams in the figures illustrate examples of the architecture, functionality, and operation of possible implementations of systems, methods, and computer program products according to various embodiments. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

It is understood that the described embodiments are not mutually exclusive, and elements, components, materials, or steps described in connection with one example embodiment may be combined with, or eliminated from, other embodiments in suitable ways to accomplish desired design objectives.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A computer-implemented method for vulnerability management, the method comprising:
identifying a series of vulnerabilities;
determining a risk associated with each vulnerability of the series of vulnerabilities;
determining one or more characteristics related to a manner of repairing each vulnerability of the series of vulnerabilities;
identifying, based on at least one commonality between the one or more characteristics, one or more subsets of vulnerabilities from the series of vulnerabilities; and
displaying the one or more subsets of vulnerabilities in an order, the order being based on the at least one commonality and the determined risk, wherein each subset is enabled to be addressed as a group.

2. The method of claim 1, wherein determining the risk includes at least one of identifying a predefined static value or calculating a dynamic value associated with each vulnerability.

3. The method of claim 1, wherein the one or more characteristics include at least one of a cost to repair a particular vulnerability, a source of the particular vulnerability, a potential side effect associated with repairing the particular vulnerability, or a risk reduction value associated with repairing the particular vulnerability.

4. The method of claim 3, wherein the source of the particular vulnerability includes at least one of a source code, a hardware location, an alert location, a location of a change required for remediation, or an owner.

5. The method of claim 3, wherein the potential side effect is determined based on at least one of predefined data or one or more queries.

6. The method of claim 3, further comprising:
determining an aggregate risk reduction value associated with each subset of vulnerabilities; and
determining an aggregate cost to repair associated with each subset of vulnerabilities.

7. The method of claim 6, wherein the order is further based on a ratio of the aggregate risk to the aggregate cost of repair.

8. The method of claim 1, further comprising repairing the one or more subsets of vulnerabilities.

9. The method of claim 8, wherein repairing the one or more subsets includes making at least one change to repair at least one vulnerability of the one or more subsets, the method further comprising verifying the at least one change.

10. The method of claim 8, wherein repairing the one or more subsets includes making at least one change to repair at least one vulnerability of the one or more subsets, the method further comprising validating a side effect associated with the at least one change.

11. A system comprising:
at least one memory storing instructions;
at least one processor configured to execute the instructions to perform operations for vulnerability management, the operations comprising:
identifying a series of vulnerabilities;
determining a risk associated with each vulnerability of the series of vulnerabilities;
determining one or more characteristics related to a manner of repairing each vulnerability of the series of vulnerabilities;
identifying, based on at least one commonality between the one or more characteristics, one or more subsets of vulnerabilities from the series of vulnerabilities; and
displaying the one or more subsets of vulnerabilities in an order, the order being based on the at least one commonality and the determined risk, wherein each subset is enabled to be addressed as a group.

12. The system of claim 11, wherein determining the risk includes at least one of identifying a predefined static value or calculating a dynamic value associated with each vulnerability.

13. The system of claim 11, wherein the one or more characteristics include at least one of a cost to repair a particular vulnerability, a source of the particular vulnerability, a potential side effect associated with repairing the particular vulnerability, or a risk reduction value associated with repairing the particular vulnerability.

14. The system of claim 13, wherein the source of the particular vulnerability includes at least one of a source code, a hardware location, an alert location, a location of a change required for remediation, or an owner.

15. The system of claim 13, wherein the potential side effect is determined based on at least one of predefined data or one or more queries.

16. The system of claim 13, the operations further comprising:
determining an aggregate risk reduction value associated with each subset of vulnerabilities; and
determining an aggregate cost to repair associated with each subset of vulnerabilities.

17. The system of claim 16, wherein the order is further based on a ratio of the aggregate risk to the aggregate cost of repair.

18. The system of claim 11, the operations further comprising repairing the one or more subsets of vulnerabilities.

19. The system of claim 18, wherein repairing the one or more subsets includes making at least one change to repair at least one vulnerability of the one or more subsets, the method further comprising verifying the at least one change.

20. A non-transitory computer-readable medium including instructions that are executable by one or more processors to perform operations comprising:
identifying a series of vulnerabilities;
determining a risk associated with each vulnerability of the series of vulnerabilities;
determining one or more characteristics related to a manner of repairing each vulnerability of the series of vulnerabilities;
identifying, based on at least one commonality between the one or more characteristics, one or more subsets of vulnerabilities from the series of vulnerabilities; and
displaying the one or more subsets of vulnerabilities in an order, the order being based on the at least one commonality and the determined risk, wherein each subset is enabled to be addressed as a group.
